(19) United States
(12) Patent Application Publication
(10) Pub. No.: US 2026/0004105 A1
(43) Pub. Date: Jan. 1, 2026

(54) ENHANCED TRANSFORMER ARCHITECTURE WITH EPISTEMIC ENCODING AND SUB-QUADRATIC ATTENTION FOR IMPROVED VERACITY AND COMPUTATIONAL EFFICIENCY

(71) Applicant: NOLA Al, Inc., New Orleans, LA (US)

(72) Inventors: Correy Allen Kowall, New Orleans, LA (US); Nivedita Sivakumar, Richardson, TX (US); Jober't Aladwan, New Orleans, LA (US); Robbie Veghlen, New Orleans, LA (US); Leo Dupuy, New Orleans, LA (US); Matthew Busenlener, New Orleans, LA (US)

(21) Appl. No.: 19/256,036

(22) Filed: Jun. 30, 2025

Related U.S. Application Data
(60) Provisional application No. 63/666,598, filed on Jul. 1, 2024.

(51) Int. Cl. G06N 3/045; G06N 3/08

(52) U.S. Cl. CPC G06N 3/045; G06N 3/08

(57) ABSTRACT

A computer-implemented transformer architecture for processing natural language input with enhanced computational efficiency and veracity verification is disclosed. The transformer generates enhanced embeddings by augmenting conventional word embeddings with semantic, positional, reliability, domain-specific feature vectors, epistemic encoding for knowledge attributes, and co-occurrence matrix analysis for semantic relationships. The transformer architecture implements selective attention processing using dynamic thresholds to determine token pair processing. Low-scoring token pairs are dropped from further processing, and high-scoring token pairs are passed directly to the output using a token bypass system. The medium-scoring token pairs are processed through the full transformer stack to determine their contextual role. This selective attention approach reduces computational complexity from quadratic to sub-quadratic time. A veracity verification system compares preliminary outputs generated by the transformer stack with a stored corpus of verified information. Semantic distance measurements are used to verify the accuracy of the generated response.

### REFERENCE TO RELATED APPLICATIONS

This application claims priority to U.S. Provisional Appl. No. 63/666,598, filed Jul. 1, 2024, titled, “AI MODEL ARCHITECTURE WITH SELECTIVE ATTENTION AND ENHANCED VERACITY”, the entire specification of which is hereby incorporated by reference in its entirety.

### BACKGROUND OF THE INVENTION

### Field of the Art

The disclosure relates to the field of transformer-based neural network architectures for natural language processing and, more particularly, to efficient computational systems with enhanced veracity verification capabilities.

### Discussion of the State of the Art

Transformer architectures are advanced artificial intelligence systems designed to understand, generate, and manipulate human language. Transformer architectures are deep learning models trained on vast amounts of text data to predict and generate human-like text. Transformer-based systems are capable of text generation, translation, summarization, question answering, code generation, and creative writing. These architectures are increasingly being used in applications, including but not limited to chatbots and virtual assistants, content creation, language translation, data analysis, and insights generation.

Although transformer architectures are revolutionizing how we interact with computers and process information, with the potential to transform various industries and aspects of daily life, they present challenges in computational efficiency and output reliability. the form of output being biased, fairness issues, and hallucinations (generating false information). Current transformer implementations have high computational requirements due to quadratic attention mechanisms, and they suffer from reliability issues, including factual inaccuracies and unsupported assertions in generated content.

Hallucinations are a significant challenge in transformer-based natural language processing systems. This term refers to the phenomenon where the architecture generate information that sounds plausible but is factually incorrect or entirely fabricated. Hallucinations occur because transformers are trained to predict likely sequences of words based on patterns in their training data, rather than on verified factual knowledge or truth validation mechanisms.

Current attention mechanisms in transformer architectures calculate attention weights for every possible token pair, resulting in quadratic computational complexity that becomes prohibitively expensive for long input sequences. This computational burden limits the practical deployment of transformer architectures in resource-constrained environments and real-time applications.

The issues of computational inefficiency and factual unreliability raise important questions about the practical deployment of transformer architectures in applications where both performance and accuracy are crucial. Hence, there is a need for enhanced transformer architectures that provide sub-quadratic computational complexity while implementing robust verification mechanisms to ensure factual accuracy of generated content.

### SUMMARY OF THE INVENTION

Accordingly, the inventor has conceived and reduced to practice, a computer-implemented transformer architecture for natural language processing with enhanced computational efficiency and improved veracity verification capabilities.

In a preferred embodiment, the transformer architecture generates enhanced embeddings that augment conventional word embeddings with multiple feature vectors. The enhanced embeddings incorporate positional encoding information, term frequency-inverse document frequency (TF-IDF) scoring, radial basis function (RBF) features for domain identification, and epistemic encoding for knowledge-related attributes

According to another aspect of the invention, the transformer architecture utilizes co-occurrence matrices to capture statistical relationships between semantic classes, enabling improved understanding of concept relationships and contextual dependencies within the natural language input.

According to another aspect of the invention, the transformer architecture implements a novel selective attention mechanism that processes token pairs based on calculated attention scores. The system employs dynamic thresholds that adapt to content characteristics to determine processing paths for different token pairs.

In another aspect of the invention, the transformer architecture implements comprehensive veracity verification using a stored corpus of verified information organized with hierarchical addressing. The corpus includes volume, chapter, paragraph, sentence, and word identifiers with attribution metadata indicating source reliability and temporal validity. The verification process decomposes preliminary outputs into individual factual assertions and calculates semantic distances between assertions and corresponding corpus entries. When semantic distances exceed predetermined thresholds, the system reconstructs responses using verified content or provides appropriate citations.

According to another aspect of the invention, the transformer architecture includes automated citation generation capabilities that provide source attribution for verified content. When responses require reconstruction based on corpus verification, the system generates appropriate citations and confidence indicators.

According to a further embodiment, the transformer architecture implements an internal monologue crossover mechanism that enables private reasoning processes. The system generates intermediate reasoning steps in an internal journal accessible only to the processing system, improving response accuracy without exposing internal deliberations to end users.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention;

FIG. 2 is a block diagram illustrating an exemplary logical architecture for a client device, according to an embodiment of the invention;

FIG. 3 is a block diagram showing an exemplary architectural arrangement of clients, servers, and external services, according to an embodiment of the invention;

FIG. 4 is another block diagram illustrating an exemplary hardware architecture of a computing device used in various embodiments of the invention;

FIG. 5 illustrates an enhanced transformer architecture with selective attention and veracity verification system, according to an embodiment of the invention;

FIG. 6 is a flowchart depicting a method for generating semantic triples, according to an embodiment of the invention;

FIG. 7 is a flowchart depicting a method for generating RBF features, according to an embodiment of the invention;

FIG. 8 is an example flowchart illustrating a method for generating enhanced embeddings, according to an embodiment of the invention;

FIG. 9 provides a visual representation of how multiple embedding components are architecturally integrated to form the enhanced embedding, according to an embodiment of the invention;

FIG. 10 is an example flowchart illustrating a method for selective processing of tokens, according to an embodiment of the invention;

FIG. 11 is an example flowchart illustrating a method of modified transformer stack processing sequence, according to an embodiment of the invention;

FIG. 12 is an example flowchart illustrating a method for post-processing verification to validate transformer outputs, according to an embodiment of the invention;

FIG. 13 illustrates a hierarchical corpus addressing and citation system, according to an embodiment of the invention;

FIG. 14A is an example flowchart illustrating a method for training transformer models with veracity enhancement capabilities; and

FIG. 14B is an example flowchart illustrating a method for training transformer models with veracity enhancement capabilities and FIG. 14B is a continuation of the method described in FIG. 14A.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions.

Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Attention Mechanism” refers to a computational technique in neural networks that allows the model to focus on specific parts of the input sequence when processing each element, typically implemented through weighted combinations of input representations.

“Attention score” refers to a numerical value calculated for each token pair that determines the computational processing path, and the score is derived from TF-IDF weights, RBF domain features, and syntactic relationships.

“Enhanced embedding” refers to a multi-dimensional token representation that augments traditional word embeddings with additional feature vectors including positional encoding, TF-IDF scores, RBF features, epistemic encoding, and semantic class information.

“Sub-quadratic Complexity” refers to computational complexity that grows slower than O(n²), achieved through selective attention processing that reduces the number of token pairs requiring full computation.

“Token pair” refers to any combination of two tokens in the input sequence for which attention weights and processing decisions are calculated.

“Dynamic threshold” refers to an adaptive boundary value that adjusts based on content characteristics, sequence length, domain type, and historical performance metrics to determine token processing paths.

“Knowledge graph” refers to a structured representation of knowledge comprising entities, relationships, and attributes organized as interconnected nodes and edges with temporal and confidence annotations.

“Veracity verification” refers to the computational process of comparing generated content against verified knowledge sources to assess factual accuracy and reliability.

“Verification threshold” refers to the maximum acceptable semantic distance between generated assertions and corpus entries for content to be considered factually supported.

“Reconstruction loop training” refers to a learning methodology in which models learn to internally generate enhancements initially provided by external components.

“Veracity flags” means explicit training signals indicating the reliability and factual accuracy of content used during model training.

“Training wheels methodology” refers to a gradual learning approach where external enhancement components are progressively replaced by internal capabilities.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

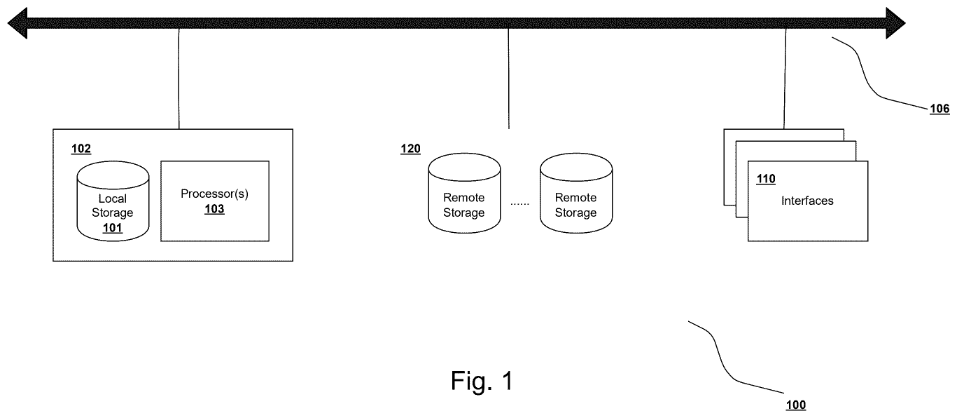

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

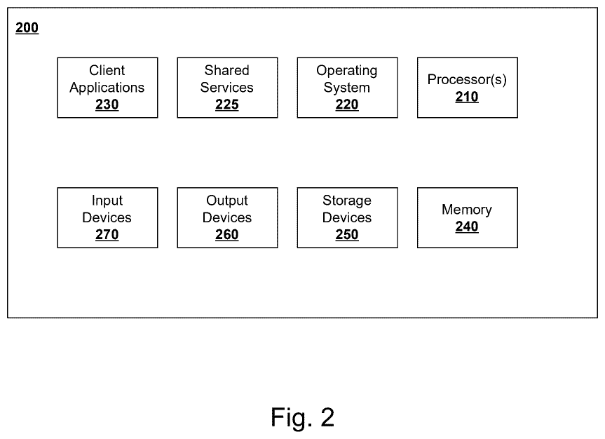

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

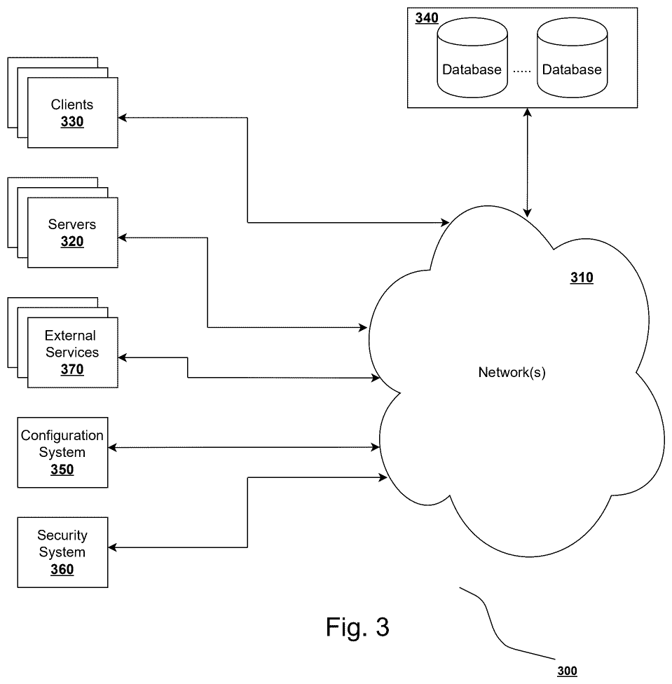

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprises or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

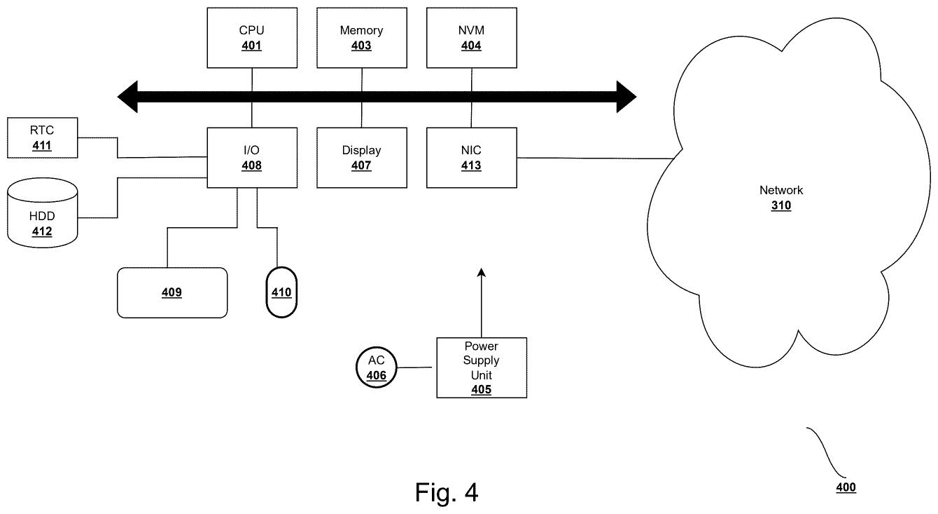

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

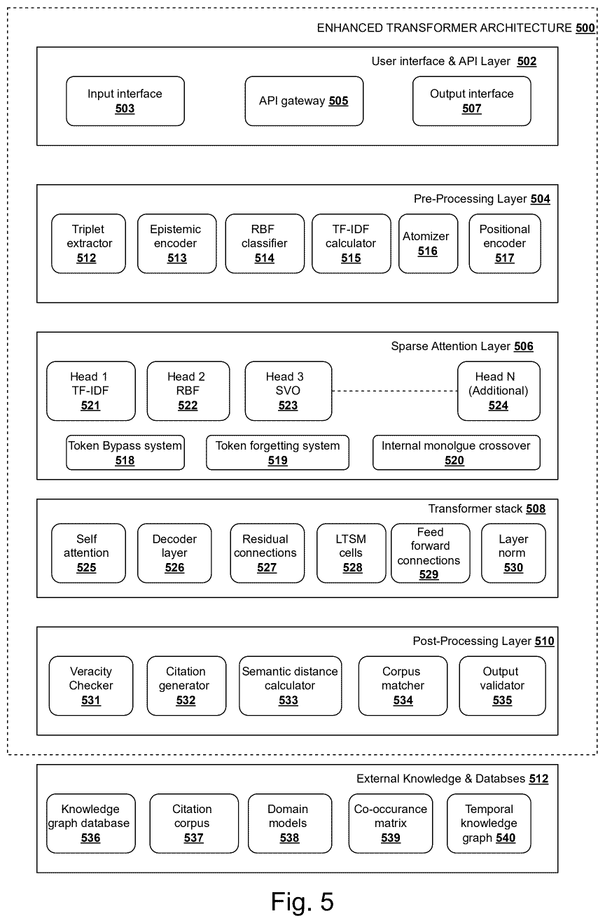

FIG. 5 illustrates an enhanced transformer 500 architecture with selective attention and veracity verification system, according to an embodiment of the invention. Enhanced transformer 500 architecture operates through a coordinated sequence of specialized processing layers that work together to achieve verifiable, efficient language generation.

The process begins when user input is entered through a user interface & API Layer 502, which manages input reception and output delivery while providing standardized API access.

Input interface 503 serves as an entry point for receiving user queries, text prompts, or natural language input through a user interface. This component handles various input formats, including conversational queries, document analysis requests, and structured data inquiries. API gateway 505 may be a middleware component that manages external Application Programming Interface (API) calls, request routing, authentication, and rate limiting. It serves as the interface between the internal architecture and external client applications. Output interface 507 may format and present verified responses to users, maintaining consistent output formatting and ensuring proper presentation of citations and veracity indicators.

The input received flows into pre-processing layer 504, where sophisticated semantic analysis extracts meaning structures, applies initial veracity assessments, and creates enriched embeddings that capture both linguistic and epistemic information about the content.

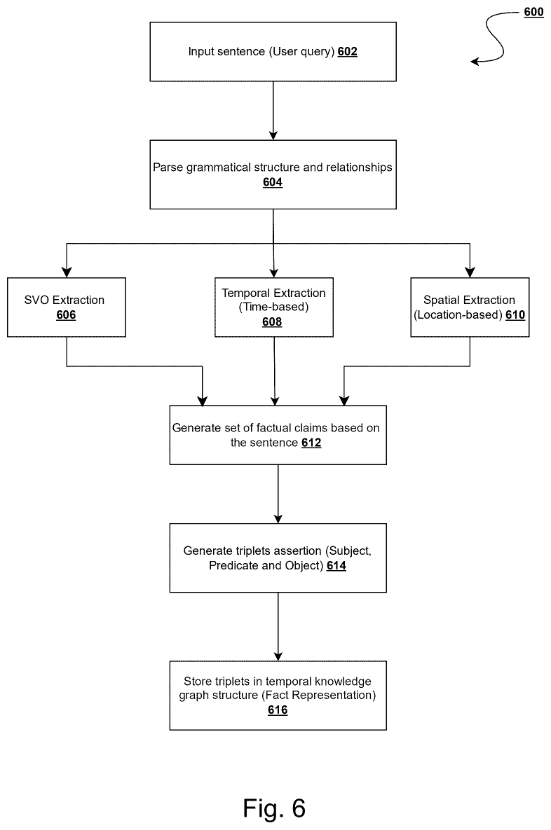

In an embodiment, triplet extractor 512 may perform SVO decomposition by breaking down sentences into their fundamental semantic components of subject (who/what), verb (action), and object (receiver of action). Details related to triplet extraction are described in FIG. 6. Triplet extractor 512 transform natural language into structured, verifiable knowledge triplets that can be fact-checked, stored, and reasoned about systematically.

In an embodiment, epistemic encoder 513 may capture a degree of certainty, belief, or knowledge confidence expressed in language. Epistemic encoder 513 processes epistemic markers including but not limited to modal verbs (might, could, should), certainty adverbs (definitely, probably), and subjective phrases (I believe, it seems).

In an embodiment, Radial Basis Function (RBF) classifier 514 may implement RBF classification to identify domain-specific language patterns and vernacular subspaces. RBF is a mathematical function that identify similarity patterns in high-dimensional space, and detect specialized vocabularies like legal jargon, medical terminology, or colloquial speech.

In an embodiment, Term Frequency-Inverse Document Frequency (TF-IDF) calculator 515 may compute TF-IDF scores to identify semantically important terms within the input context. TF-IDF is a numerical statistic that reflects how important a word is to a document within a collection of documents.

In an embodiment, positional encoder 517 may enhances traditional positional encodings with semantic position markers and knowledge graph relationship indicators.

The components, including positional encoder 517, TF-IDF calculator 515, RBF classifier 514, epistemic encoder 513, and triplet extractor 512, may operate simultaneously along with traditional word embeddings. The outputs from each of these components may be processed by atomizer 516.

In an embodiment, atomizer 516 includes a sophisticated fusion mechanism that acts as a hierarchical composition engine to integrate epistemic co-factors, add attentional foci, and embed knowledge representations as necessary. Atomizer 516 combines these heterogeneous semantic components into a unified enhanced embedding that is representative of rich semantic, epistemic, and veracity information gathered from all preprocessing components.

The enhanced embeddings then proceed to the sparse attention layer 508 that implements a multi-head selective attention processing to reduce computational complexity by intelligently focusing only on the most relevant token relationships while applying domain-specific attention patterns.

In an example embodiment, enhanced transformer architecture may implement a specialized multi-headed attention mechanism comprising multiple specialized attention heads, each configured to focus on specific semantic, syntactic, or domain-specific aspects of the input data. Unlike conventional transformer attention mechanisms that apply uniform attention patterns across all heads, the present invention assigns dedicated functions to each attention head to improve processing efficiency and accuracy.

Head 1 TF-IDF may be an attention head 521 configured to identify and focus on the highest-ranked content words within the input sequence based on Document Frequency (TF-IDF scoring. The head selectively attends to tokens that carry the most informational weight, effectively filtering noise and focusing computational resources on semantically significant elements. A TF-IDF calculator 515 may rank/score content members of each sentence, and this head processes the top-ranked/score elements to establish primary semantic focus points.

Head 2 may be RBF domain-specific attention head 522 that applies specialized processing based on detected vernacular or technical language patterns. RBF attention head 522 specializes in identifying vernacular subdomains and linguistic context within the input. This head utilizes RBF features to determine which subset of the embedding space applies to the current context, enabling the system to distinguish between different linguistic registers such as legal terminology, technical jargon, colloquial speech, or domain-specific vocabularies.

Head 3 may be SVO structural attention head 523, focusing on grammatical relationships and semantic dependencies between sentence components. This head focuses specifically on Subject-Verb-Object (SVO) decomposition and syntactic structure analysis. It identifies and attends to the core propositional elements within sentences, enabling the system to extract fundamental semantic relationships and factual assertions. The SVO attention head facilitates the decomposition of complex sentences into their constituent propositional claims, supporting both semantic understanding and veracity verification processes.

Head N may represent additional specialized attention heads for temporal relationships, sentiment analysis, or other domain-specific semantic aspects. These may include additional TF-IDF processing for lower-ranked but relevant content, corpus attention for external knowledge integration, or specialized attention for temporal, spatial, or causal relationships identified within the input.

In an initial embodiment, attention heads are populated using a rule-based system that extracts subject, verb, and object components, or the top three TF-IDF ranked content members from the current sentence. This selective attention approach leverages contextual information while constraining the attention mechanism to focus on semantically and syntactically relevant elements, thereby reducing computational complexity from O(n²) to a more manageable sub-quadratic complexity.

In an embodiment, token bypass system 518 may be a computational efficiency technique that routes tokens directly to output when minimal transformation is needed. Token bypass system 518 is a routing mechanism that determines whether tokens require full transformer processing or can bypass certain computational layers.

In an embodiment, token forgetting system 519 may implement attention dropout mechanisms using neurobiological forgetting rules (such as Oja's rule) to reduce computational load on less relevant token relationships. Oja's rule is a mathematical formulation of Hebbian learning that strengthens connections between frequently co-activated elements while weakening unused connections.

In an embodiment, internal monologue crossover 520 may be a mechanism to allow the model to generate internal reasoning chains and self-prompting sequences that remain hidden from the final output.

The selectively processed tokens advance through transformer stack 528, where traditional transformer operations are enhanced with conditional LSTM integration and optimized feed-forward networks to generate preliminary outputs.

Self-attention layers 525 perform processing of token pairs for tokens selected by sparse attention layer 508. Self-attention layers 525 may perform parallel processing of multiple attention heads, and concatenate and project the head outputs. Decoder layer 526 may include standard transformer decoder components enhanced with conditional LSTM integration for improved sequential processing. Feed-forward connections 529 are enhanced feed-forward networks with adaptive sizing and optimized activation functions. LSTM cells 528 may include conditionally integrated long short-term memory units that provide enhanced sequential memory for complex temporal dependencies. LSTM cells 528 may be specialized neural network units designed to remember information over long periods while selectively forgetting irrelevant data. Residual connections 529 (also called skip connections or shortcut connections) are direct pathways that allow information to “skip” one or more layers in a neural network by adding the input of a layer directly to its output. Layer Norm 530 may include normalization layers that stabilize training and improve gradient flow throughout the network.

Output generated by transformer stack 508 may be processed by post-processing layer 510. Post-processing layer 510 may perform comprehensive veracity verification by comparing generated content against verified knowledge sources, automatically generating citations for factual claims, and ensuring output quality before final delivery.

Throughout this entire process, external knowledge and databases 512 may provide continuous access to structured knowledge graphs, citation corpora, and domain-specific models that enable both the semantic enhancement during preprocessing and the factual verification during post-processing, creating a complete system that addresses both computational efficiency and output reliability.

In an embodiment, a knowledge graph is a structured representation of knowledge that captures entities, their attributes, and the relationships between them. Knowledge graph database 536 may be a structured repository containing entity relationships, temporal knowledge graphs, and confidence-weighted assertions.

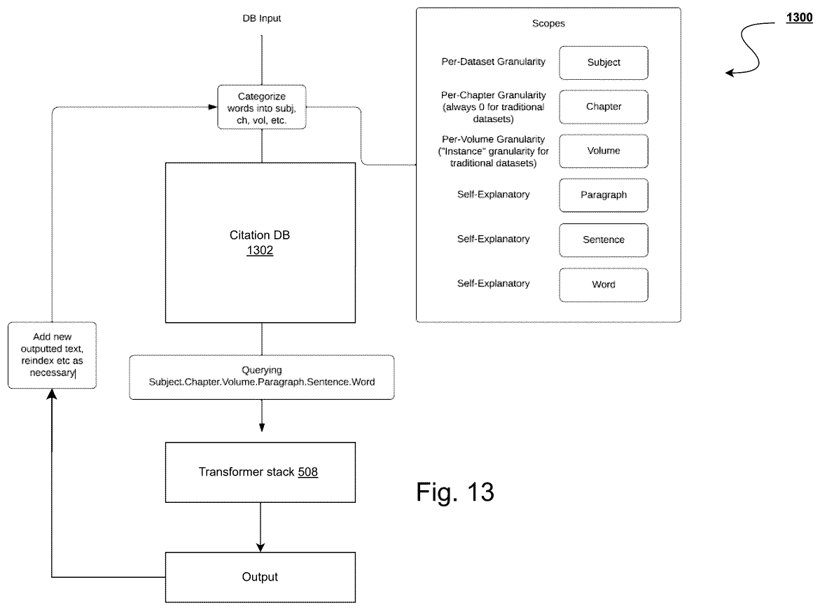

In an embodiment, citation corpus 537 may be a curated database of verified sources organized hierarchically by subject, chapter, paragraph, sentence, and word levels with associated metadata and reliability scores. Details related to citation corpus 537 are described in FIG. 13.

In an embodiment, domain models 538 may be specialized knowledge repositories containing technical vocabularies, professional jargon patterns, and domain-specific linguistic structures.

In an embodiment, co-occurrence matrix 539 may be a statistical analysis database capturing semantic relationships, contextual associations, and frequency patterns for different knowledge domains. A co-occurrence matrix is a mathematical representation showing how frequently different terms appear together in similar contexts.

In an embodiment, temporal knowledge graph 540 may be a time-sensitive knowledge representation that maintains historical validity periods and tracks knowledge evolution over time.

FIG. 6 is a flowchart depicting a method 600 for generating semantic triples, according to an embodiment of the invention. Method 600 illustrates a process for decomposing input sentences into semantic triples and storing them in a temporal knowledge graph structure.

As natural language is ambiguous and hard to verify, triplet extractor 512 breaks sentences into Subject-Predicate-Object triplets and creates verifiable facts that can be individually checked against knowledge bases. This helps in eliminating hallucinations.

Method 600 may be performed by triplet extractor 512. At step 602, method 600 begins with receiving input from the user via input interface 503.

At step 604, triplet extractor 512 may parse the grammatical structure of the input sentence to identify syntactic relationships between words and phrases. This complex sentence contains multiple factual claims that need to be separated and verified individually. Consider an example, when the received input is “Albert Einstein developed the theory of relativity in 1905 while working in Switzerland.” Several words indicate grammatical relationships, including but not limited to “developed,” “in 1905”, and “in Switzerland”.

At step 606, triplet extractor 512 may extract Subject-Verb-Object relationships from the parsed sentence, identifying the core semantic components. Continuing the example introduced in step 604, the SVO relationships may include “Einstein developed theory” and “theory is type of relativity”

At step 608, temporal extraction may be performed to extract time-related information from the sentence to capture temporal context and relationships. At step 610, spatial extraction may be performed to extract location or spatial information and provide geographical or positional context. In the Einstein example, temporal extraction generates “1905” and spatial extraction generates “Switzerland”.

At step 612, triplet extractor 512 may generate a set of factual assertions that represent the meaning of the original sentence. For example, the factual assertations may include: “Einstein developed the theory of relativity,” “development occurred in 1905”, and “Einstein worked in Switzerland”.

At step 614, triplet extractor 512 may generate triplets' assertion (Subject, Predicate, Object). The factual claims are structured into triplet representations following the standard Resource Description Framework (RDF) style format using subject-predicate-object relationships. For example, the triplet's assertion may include “Einstein is a physicist,” “theory of relativity published in 1905”, “Switzerland is the location of scientific work.”,

At step 616, generated triplets may be stored in temporal knowledge graph structure 540. By decomposing sentences into verifiable facts stored in a temporal structure, the system can check each claim against established knowledge before generating output. The generated triplets create a structured representation of facts that can be queried and referenced for veracity checking. The combination of fact decomposition with temporal and spatial awareness creates a foundation for both enhanced attention mechanisms and reliable veracity checking.

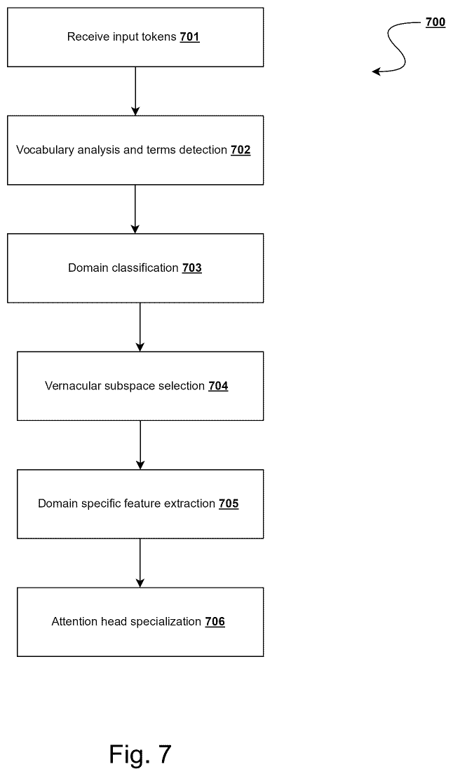

FIG. 7 is a flowchart depicting a method 700 for generating RBF features, according to an embodiment of the invention. RBF classifier 514 is a feature processing system that partitions the embedding space into vernacular-specific domains. Based on the vernacular-specific domains, domain-aware attention mechanisms are applied.

At step 701, input tokens are received by RBF classifier 514. At step 702, a comprehensive vocabulary analysis may be conducted to detect domain-specific terminology. RBF classifier 514 may extract token embeddings and analyze the vocabulary for domain indicators. The vocabulary analysis may involve term frequency analysis to count domain-specific terms, co-occurrence pattern analysis to understand term relationships, and domain vocabulary matching against known domain lexicons to establish initial domain probability estimates.

At step 703, RBF classifier 514 may measure distance to known RBF centers and compare it with domain centers. A proximity assessment is performed to determine closeness to vernacular spaces. The core mathematical foundation relies on Manhattan distance calculation between token embeddings and predefined RBF centers representing different vernacular domains. The system may maintain RBF centers for various vernacular domains, including legal language (trained on legal document embeddings), patent language (trained on patent specifications), K-fabe terminology (wrestling/carnival language), CB radio communications, medical/clinical language, and general English. Patent center may be at different distances for legal domain, general domain, medical domain, K-fabe terminology and CB Radio. Based on the token embedding, the domain with the shortest distance (largest confidence) is selected.

At step 704, upon domain selection, RBF classifier 514 performs vernacular subspace selection by restricting processing to domain-relevant embedding dimensions, reducing the vocabulary scope from a high number of terms to minimal relevant terms that leads to reduction in computational requirements.

At step 705, domain-specific feature are extracted by utilizing RBF kernel functions the system generates feature vectors by computing RBF features for all centers and applying learned domain weights through element-wise multiplication to produce final domain-aware features.

The RBF feature processing assists enhanced transformer 500 in achieving sub-quadratic attention complexity by partitioning the embedding space into vernacular-specific domains and applying domain-aware attention mechanisms. and applying domain-aware attention mechanisms.

In an embodiment, token pairs may be are routed to domain-specific attention heads, with patent tokens directed to patent-specialized heads, legal tokens to legal-specialized heads, and so forth, enabling each head to learn domain-specific attention patterns while reducing cross-domain interference and improving semantic understanding within specialized contexts.

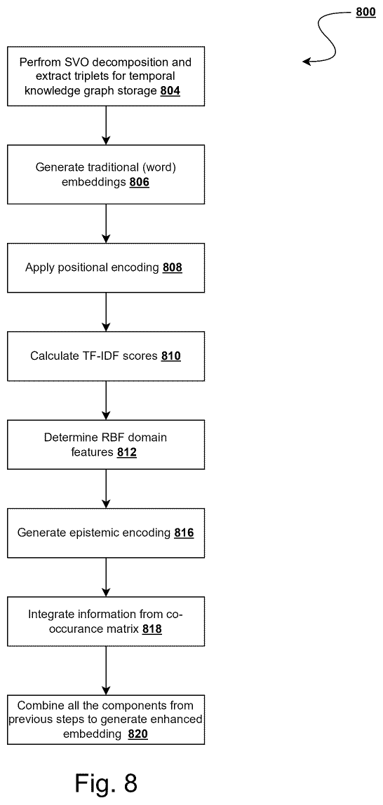

FIG. 8 depicts a flowchart illustrating a method 800 for generating enhanced embeddings, in accordance with an embodiment of the invention. Unlike traditional embeddings that only capture basic word meanings, this enhanced embedding system creates a multi-dimensional understanding that enables both improved veracity (truthfulness) and selective attention capabilities.

At step 804, triplet extractor 512 breaks down sentences into their logical components Subject-Verb-Object (SVO), and creates structured triplets for storage in temporal knowledge graph storage 540. By decomposing language into logical assertions, enhanced transformer 500 can later verify each claim independently against known facts, directly supporting veracity checking. This structured approach allows the attention mechanism to focus on specific factual relationships rather than processing entire sentences as black boxes.

At step 806, traditional word embeddings are generated. Standard semantic representations for each token is generated.

At step 808, positional encoding is applied to maintain sequence information using positional encoder 517. They provide the baseline semantic understanding that all other enhancements build upon, ensuring compatibility with existing transformer architectures.

At step 810, TF-IDF calculator 515 computes TF-IDF scores. TF-IDF scores indicate the importance of each word within the specific context and broader corpus. TF-IDF scores help the attention mechanism focus on the most semantically significant words rather than common filler words

At step 812, RBF classifier 514 determines RBF domain features for vernacular and domain-specific language identification. RBF classifier 514 identifies which vernacular or specialized domain the text belongs to (e.g., legal language, medical terminology, casual conversation). RBF domain features allow the system to apply domain-appropriate attention patterns. For example, in the case of legal text, it might pay more attention to precedent citations, while in casual conversation, it focuses on sentiment and context clues.

At step 816, epistemic encoder 513 generates epistemic embedding. Epistemic encoder 513 identifies the “knowledge quality” of statements—whether they express certainty, speculation, hearsay, or opinion.

At step 818, information from co-occurrence matrices is integrated to capture semantic relationships. In an embodiment, co-occurrence matrix 539 may incorporate statistical knowledge about which concepts commonly appear together in reliable sources. In some embodiments, co-occurrence patterns may help identify when unusual word combinations might indicate potential hallucinations. Epistemic encoding allows the system to distinguish between “The Earth is round” (high certainty, verifiable fact) versus “I think the weather will be nice” (personal opinion, not verifiable).

At step 820, atomizer 516 combines these heterogeneous semantic components into a unified enhanced embedding that is representative of rich semantic, epistemic, and veracity information gathered from all preprocessing components.

This enhanced embedding system transforms each word into a rich information packet that includes what it means (traditional semantics), how important it is (TF-IDF weighting), how reliable it is (veracity indicators), what domain it belongs to (RBF features), what kind of knowledge claim it makes (epistemic encoding), and how it relates to other verified concepts (co-occurrence patterns).

This multi-dimensional understanding enables enhanced transformer 500 to make intelligent decisions about where to focus attention (selective attention) and how to assess the truthfulness of both input and generated content (enhanced veracity). Rather than treating all words equally, enhanced transformer 500 may prioritize attention on high-importance, high-veracity content while being appropriately skeptical of speculative or unverifiable claims.

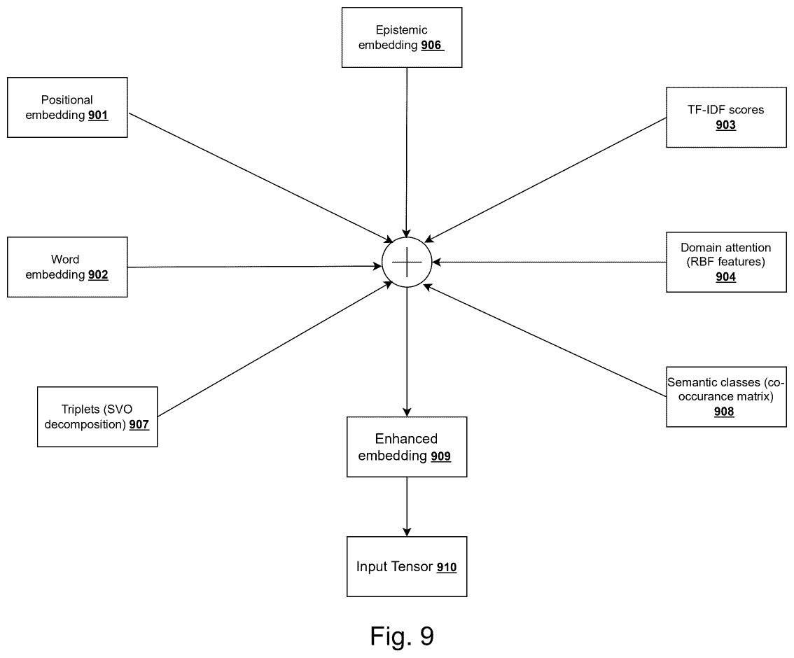

FIG. 9 provides a visual representation of how multiple embedding components are architecturally integrated to form the enhanced embedding. While FIG. 8 shows the process of creating enhanced embeddings, FIG. 9 illustrates the structural relationships and data flow between components. Each of the components (901-904, 906-910) has been discussed in FIG. 8.

Unlike traditional single-layer embeddings, this architecture shows how different information types maintain their distinct identities while contributing to a unified representation. Each component (901-904, 906-910) feeds into the enhanced embedding 909 independently, allowing for modular updates and component-specific optimization.

The architecture demonstrates that additional embedding types can be integrated without restructuring the entire system. For example, new domain-specific features or additional veracity indicators can be added as parallel components that operate externally.

Input Tensor 910 represents a final mathematically combined representation that maintains dimensional separation for each information type, enabling the transformer's attention mechanism to selectively focus on different aspects (veracity vs. semantics vs. domain specificity) based on context needs.

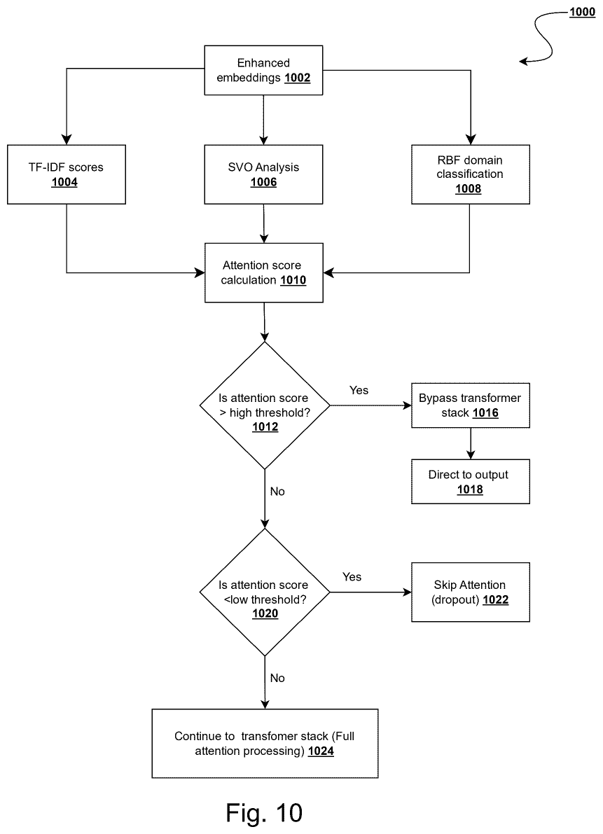

FIG. 10 is an example flowchart illustrating a method 1000 for selective processing of tokens, according to an embodiment of the invention. An intelligent attention dropout mechanism enables sub-quadratic time complexity by selectively processing tokens based on their importance scores. A token bypass system 518 may determine whether tokens require full transformer processing or can bypass certain computational stages.

At step 1002, method 1000 begins with receiving enhanced embeddings 902 generated in FIG. 9 by pre-processing layer 504. These embeddings contain positional encoding, TF-IDF scores, RBF features, veracity flags, and epistemic information. Unlike traditional transformers that work with basic positional encodings, enhanced transformer 500 works with enhanced embeddings 902 that carry semantic intelligence. By using enhanced embeddings 902, intelligent routing decisions may be performed earlier in the pipeline, avoiding expensive calculations on tokens that are already flagged as low-value.

At step 1004, TF-IDF calculator 515 may compute TF-IDF scores for each token. TF-IDF scores help in identifying semantically important terms within the input context. TF-IDF is a numerical statistic that reflects how important a word is to a document within a collection of documents. Higher TF-IDF scores indicate greater semantic importance

At step 1006, triplet extractor 512 may perform Subject-Verb-Object decomposition on input tokens and identifies grammatical roles and syntactic importance. By identifying syntactic roles, enhanced transformer 500 may prioritize tokens that carry semantic content over functional words. Tokens that serve as subjects, main verbs, or primary objects are prioritized.

At step 1008, RBF classifier 514 may apply Radial Basis Function features to identify domain-specific contexts and determine vernacular subspaces (e.g., legal, medical, technical language). Unlike traditional transformers that do not consider domain switching, the use of RBF features identifies domain-specific patterns based on legal language, medical terminology, and casual conversation may require different attention patterns. Traditional models treat all text as homogeneous.

At step 1010, enhanced transformer 500 combines inputs from TF-IDF scores, SVO analysis, and RBF domain classification to generate a composite attention score representing token importance. Unlike a traditional transformer that processes all tokens, enhanced transformer 500 determines which tokens deserve computational resources.

At step 1012, enhanced transformer 500 may determine whether the attention score for token pair is beyond a high threshold. The steps 1012-1024 are performed for each token pair.

At step 1012, when the attention score for the token pair is above the high threshold, then at step 1016 the token pairs may bypass the transformer stack and be directly sent to the output (step 1018). High-scoring token pairs do not need extensive processing as their importance is already established. This type of minimal processing preserves computational resources.

At step 1012, when the attention score is below the high threshold, then at step 1020 enhanced transformer 500 determines whether the attention score is below a low threshold.

At step 1020, when the attention score of the token pair is below the low threshold, then at step 1022 enhanced transformer 500 drops the token pair. Token pairs with very low importance scores are dropped. The use of the low threshold ensures that selective forgetting is used to reduce computational load and prevents irrelevant tokens from consuming processing resources. The dropping of tokens based on semantic irrelevance helps in effectively managing the memory.

At step 1024, when the attention score is neither above the high threshold nor below the low-threshold, token pairs are considered as having moderate importance scores. At step 1024, these token pairs with moderate importance are sent to transformer stack 508. These tokens receive full multi-head attention computation. Moderate-scoring tokens represent the genuine uncertainty cases where full attention is justified. These tokens carry potential semantic weight but need computational analysis to determine their role.

Unlike traditional attention that requires n² calculations, enhanced transformer 500 reduces O(n)² attention calculations by processing only necessary token pairs, and computation power is allocated based on the token pair importance. The use of RBF features enables specialized processing for different knowledge domains.

Enhanced transformer 500 may implement adaptive thresholds (low threshold and high threshold) based on content domain (technical vs. conversational), sequence length, complexity, and historical performance metrics. The use of adaptive thresholding results in a significant reduction in computational resources.

The dropping of tokens with low-confidence scores and prioritization of tokens with high-confidence scores reduces the noise that leads to hallucinations. The outputs from the sparse attention layer 506 are fed into transformer stack 508 for further processing.

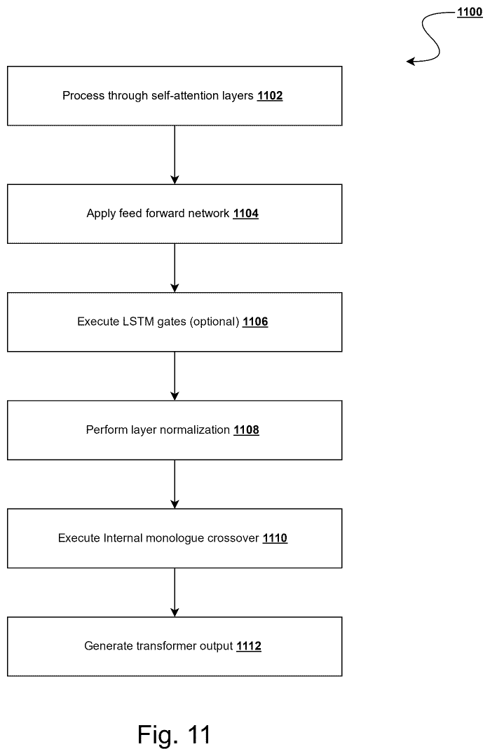

FIG. 11 is an example flowchart illustrating a method 1100 of modified transformer stack processing sequence.

At step 1102, the enhanced embeddings (containing RBF features, epistemic encoding, TF-IDF scores, etc.) are processed through multi-head self-attention mechanisms. Unlike standard transformers, transformer stack 508 implements the attention dropout mechanism enabled by the sparse attention layer 506. The attention mechanism selectively focuses on token pairs based on Subject-verb-object (SVO) decomposition results, RBF domain features for vernacular identification, and TF-IDF importance scores. The attention dropout occurs here, where certain token pairs are deliberately ignored based on the enhanced embedding features, achieving sub-quadratic time complexity.

At step 1104, feed-forward neural network (FFN) layer processes the attention-weighted representations through two linear transformations with a ReLU activation in between. While this step itself is generic, it operates on the attention-modified representations that carry the enhanced semantic information.

At step 1106, LSTM cells may be conditionally integrated into certain decoder layers. The LSTM provides sequential memory capabilities beyond standard attention, enhances processing of temporal dependencies, maintains state across processing steps, and improves handling of long-range dependencies. The “optional” terms indicates that the LSTM gates are used only in specific layers based on configuration (recurrent_layer_indices), allowing selective application where sequential processing provides the most benefit.

At step 1108, standard layer normalization may be applied to stabilize training and improve convergence. This normalizes the layer inputs to have zero mean and unit variance, which is crucial for deep network training stability.

At step 1110, an internal monologue crossover 520 is executed. Internal monologue crossover 520 refers to the implementation of a “private journal”. The private journal allows the transformer to generate output that only it can read. An internal dialogue system for chain-of-reasoning may be created that enables enhanced transformer 500 to write notes to itself during processing. This type of internal dialogue system addresses hallucination issues by allowing the model to “think through” responses before generating final output.

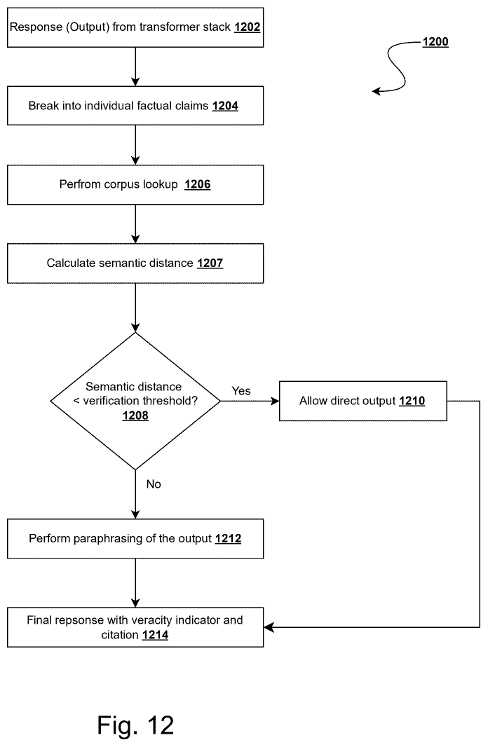

At step 1112, transformer output is generated for a received query. The transformer output includes a multi-layered output structure with the text response plus all the enhanced semantic, and reasoning information needed for the post-processing verification steps (described in FIG. 12). This enhanced output is what enables the subsequent veracity checking, citation generation, and fact verification that are core to preventing hallucinations in the system.

FIG. 12 is an example flowchart illustrating a method 1200 for post-processing verification to validate transformer outputs, according to an embodiment of the invention.

At step 1202, enhanced transformer 500 may generate an initial response to the user query, incorporating all the advanced features, including enhanced embeddings, sparse attention mechanisms, and epistemic encoding. The output represents the transformer's first attempt at generating a factually grounded response.

At step 1204, enhanced transformer 500 may perform comprehensive propositional decomposition using Subject-Verb-Object (SVO) analysis to extract individual factual claims (assertions) that can be independently verified. An iterative decomposition process recursively breaks down complex sentences into simpler constituent claims. The system analyzes the grammatical structure to capture hierarchical semantic relationships. Phrase-level reconstruction may be used to identify meaningful phrase groupings that contribute semantic value. The system produces a comprehensive set of factual statements. Each claim is represented as a structured triple (Subject, Predicate, Object) and may maintain a semantic coherence while being independently verifiable.

At step 1206, each extracted factual claim may undergo systematic comparison against the citation corpus and knowledge graph database. This process utilizes the corpus addressing system to locate relevant reference materials and potential matches. A multi-level addressing is used to search across volume, chapter, paragraph, sentence, and word granularities. A citation database query is used to access structured citation information with source attribution. The retrieval process generates semantic embeddings for each claim, performs vector similarity searches across corpus embeddings, ranks potential matches by semantic relevance, filters results using RBF domain classification, and compiles candidate reference materials for subsequent distance calculation.

At step 1207, enhanced transformer 500 may computes semantic distance metrics between each extracted claim and its nearest neighbors in the citation corpus, incorporating multiple similarity measures including vector cosine similarity as the primary embedding space distance measure, semantic path distance through knowledge graph relationships, syntactic similarity comparing grammatical patterns, lexical overlap with synonym consideration, and domain-adjusted distance modified by RBF classification.

The calculation includes contextual adjustments for source reliability weighting based on attribution quality, temporal relevance accounting for information decay, domain expertise weighting from authoritative sources, and citation chain analysis considering indirect verification networks. This produces numerical distance scores (0.0 for exact matches, 1.0 for no similarity), confidence intervals, lists of nearest neighbor matches with individual scores, source attribution information, and domain classification confidence.

At step 1208, enhanced transformer 500 may evaluate whether the calculated semantic distance is below a verification threshold. Claims demonstrating sufficient corpus support (below threshold) proceed to step 1210 with direct output approval, where the system documents supporting corpus sources, maintains attribution links, preserves original semantic structure, records confidence metrics, cross-references with multiple sources when available, verifies consistency across reference materials, maintains semantic coherence, and prepares citation metadata for transparent attribution.

At step 1208, for claims exceeding the semantic distance threshold, the system, at step 1212 attempts paraphrasing to rephrase content using corpus language while preserving essential meaning and factual accuracy. The paraphrasing methodology includes synonym substitution with corpus-verified alternatives, structural reorganization maintaining semantic content, terminology alignment using domain-appropriate corpus language, factual preservation ensuring core assertions remain unchanged, and style harmonization matching corpus writing patterns. In some cases, when an output cannot be constructed from the citable materials, the original sentences may be replaced with a citation.

At step 1214, method 1200 culminates in a final response assembly where the system compiles verified, paraphrased, or cited content into a coherent response with comprehensive documentation of the verification process and source materials.

FIG. 13 illustrates a hierarchical corpus addressing and citation system 1300, according to an embodiment of the invention. Hierarchical corpus addressing and citation system 1300 categorizes and organizes training data to improve the veracity and traceability of transformer outputs. Citation database 1302 is a central repository that stores categorized information with hierarchical addressing schemes. Hierarchical corpus addressing and citation system 1300 includes scopes with multiple granularity levels for data organization. A per-dataset granularity is associated with subject-level categorization. A per-chapter granularity refers to traditional dataset organization by chapters. A per-chapter granularity refers to a traditional dataset organization by chapters. A per-volume granularity refers to instance-level granularity for traditional datasets. Paragraph, Sentence, and Word-level addressing are self-explanatory.

DB Input feeds into a categorization system that processes words into subject, chapter, volume, and other hierarchical categories. Hierarchical corpus addressing and citation system 1300 supports querying by subject, chapter, volume, paragraph, sentence, and word, enabling precise retrieval of relevant information. Citation database 1302 interfaces with the transformer stack 508 through querying mechanisms that retrieve relevant cited material. Output validation may be performed against stored citations. The addition of new output text and reindexing ais performed a necessary.

In an embodiment, a feedback mechanism enables new transformer outputs to be added back to the citation database, continuously expanding the corpus and improving future veracity checks. This architecture enables the system to maintain detailed provenance tracking of all information, supporting the post-hoc veracity checking described in the invention by providing a structured, addressable corpus against which generated outputs can be validated and cited.

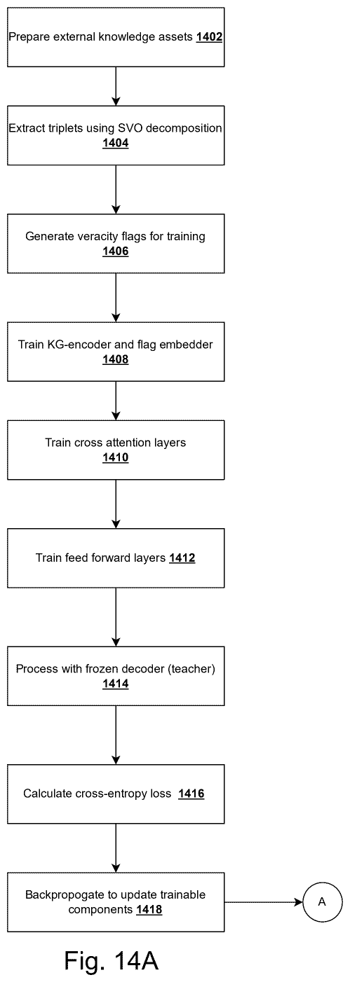

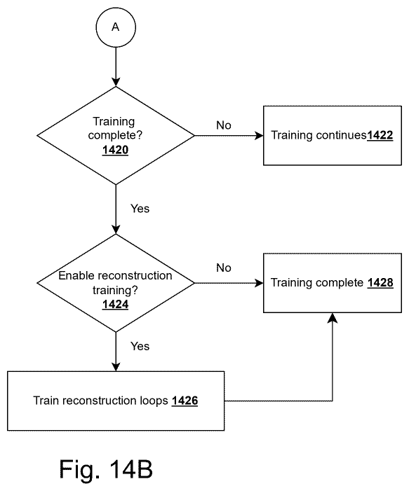

FIG. 14A is an example flowchart illustrating a method for training transformer models with veracity enhancement capabilities. FIG. 14B continuation of the method described in FIG. 14A. The training process implements a sophisticated veracity-aware learning methodology that teaches the transformer model to recognize and generate reliable, factually grounded content. This training approach utilizes external knowledge assets, supervised veracity flagging, and fusion techniques to create a model capable of self-sufficient accuracy assessment.

At step 1402, the training process may begin with the preparation of external knowledge assets that serve as authoritative sources for veracity assessment. These external assets include the knowledge graph, corpus, and tableau containing truthful assertions. The knowledge graph functions as reference material, providing structured semantic relationships and verified factual information. The corpus serves as a comprehensive collection of verified textual content with explicit veracity annotations and source attribution for factual claims. The tableau represents a curated collection of verified truthful assertions that serve as standard examples during training. These external assets provide the foundational knowledge base against which the model learns to assess information reliability and factual accuracy.

At step 1404, a preprocessing phase may implement the sophisticated propositional decomposition methodology by applying Subject-Verb-Object (SVO) analysis to systematically decompose all training content into constituent factual claims. This process utilizes syntactic frameworks that leverage both dependency and phrase structure analysis to extract semantic triads consisting of subject, predicate, and object relationships. The decomposition process traverses dependency trees to capture hierarchical semantic relationships while reconstructing phrase-level groupings that contribute semantic meaning. This systematic extraction creates factual claims that can be independently verified and used for veracity assessment training, with each triplet representing a fundamental assertion that populates the temporal knowledge graph 540 structure.

At step 1406, veracity flags may be generated, and these flags serve as explicit training signals for the model's veracity assessment capabilities. The flag is used during training to learn relevant and irrelevant embeddings. For example, “Flag 1, kg return is the answer, Flag 0, kg return is irrelevant.” These flags analyze each piece of training content for factual reliability, determine appropriate confidence levels based on source quality and verification status, and assign categorical indicators that demonstrate various levels of factual certainty. The flag generation process creates training examples that teach the model to distinguish between reliable and unreliable information patterns while establishing negative examples that show false or questionable information characteristics. These veracity flags provide explicit supervision that guides the model's learning of accuracy assessment capabilities during the training process.

At step 1408, the training process may focus on two primary trainable components that process the external knowledge assets and veracity signals. The knowledge graph encoder learns to transform structured knowledge graph information into embeddings compatible with the transformer architecture, processing knowledge graph triplets and creating embedding representations for entities, relations, and temporal information. Flag embedder is designed to process veracity flags and convert them into meaningful representations that guide the model's attention and processing decisions, learning to translate explicit veracity annotations into internal representations that enhance factual accuracy. Both components learn through supervised training to represent not just factual information, but also the reliability and contextual appropriateness of that information based on source attribution and verification status.

At step 1410, veracity learning process continues with training cross-attention layers that learn to effectively combine knowledge graph information with input prompts and veracity flags. Two cross-attention layers are implemented. The first cross-attention layer focuses on aligning knowledge graph encoding with veracity flags, learning to weight knowledge graph information based on reliability indicators, and developing attention patterns that prioritize verified information. The second cross-attention layer aligns knowledge graph encoding with input prompts, learning to identify relevant knowledge for specific queries and developing contextual understanding that connects user needs with available verified information. This fusion methodology teaches the model to systematically combine external knowledge with user context while maintaining veracity awareness throughout the attention process.

At step 1412, the feed forward network (FFN) component learns to project the fused embeddings from the fusion process into the input space of the base transformer model. FFN is the necessary last layer to project the encoded information that we derive from all our attentional layers onto the LLM input space. The FFN learns to adapt the rich representations created by the cross-attention layers into a format that the base transformer can effectively process, ensuring that veracity-enhanced information integrates seamlessly with the model's existing language generation capabilities.

At step 1414, the training methodology employs a frozen base decoder that serves as a “teacher” component, providing stable reference behavior while the enhancement components learn appropriate veracity-aware modifications. The frozen decoder processes the fused embeddings that result from the fusion process and generates probability distributions over possible outputs, serving as a baseline for measuring the impact of veracity enhancements. This approach ensures that veracity learning enhances rather than replaces the base model's language generation capabilities, providing stability during training while allowing systematic improvement of factual accuracy.

At step 1416, the training process employs cross-entropy loss calculation to measure the difference between generated outputs and target responses, with a specific focus on veracity considerations. The loss calculation compares the probability distributions generated by the frozen base decoder when processing enhanced embeddings against target distributions that represent ideal veracity-aware responses. The cross-entropy loss guides the training process toward producing responses that are both linguistically natural and factually reliable.

At step 1418, the optimization process implements selective backpropagation that updates only the trainable enhancement components while preserving the frozen base decoder. The backpropagation flows through the fusion components including the cross-attention layers and feed-forward networks, updates the KG encoder to improve knowledge graph representation and integration, modifies the flag embedder to enhance veracity signal processing, and optimizes the projection mechanisms for seamless integration with the base model.

At step 1420, the training process continues iteratively until the model demonstrates successful learning of veracity assessment capabilities. The convergence assessment involves monitoring the model's ability to distinguish reliable versus unreliable information patterns, evaluating the effectiveness of knowledge integration with user queries, and measuring the development of appropriate attention focusing on relevant and verified information. Training completion is determined when the model consistently demonstrates improved factual accuracy while maintaining natural language generation quality, shows appropriate confidence calibration where certainty correlates with actual accuracy, and successfully integrates external knowledge sources without degrading response coherence. The iterative training continues until these veracity learning objectives are achieved.

At step 1420, the training process continues iteratively until the model demonstrates successful learning of veracity assessment capabilities. The convergence assessment involves monitoring the model's ability to distinguish reliable versus unreliable information patterns, evaluating the effectiveness of knowledge integration with user queries, and measuring the development of appropriate attention focusing on relevant and verified information. Training completion is determined when the model consistently demonstrates improved factual accuracy while maintaining natural language generation quality, shows appropriate confidence calibration where certainty correlates with actual accuracy, and successfully integrates external knowledge sources without degrading response coherence. At step 1422, iterative training continues until these veracity learning objectives are achieved.

At step 1424, the training process determines whether to implement reconstruction loop training that teaches the model to internally generate the enhancements that were initially provided externally. This optional phase enables the model to develop self-sufficient veracity assessment capabilities that reduce dependency on external enhancement components during inference.

At step 1424, when reconstruction training is enabled, then at step 1426, the system implements the training wheels methodology, where the model learns to reconstruct the enhanced inputs at the output layer, gradually developing the capability to generate these enhancements internally. The reconstruction training ensures that the model can eventually operate without the external enhancement components while maintaining veracity awareness, developing internal confidence assessment capabilities that substitute for external veracity indicators.

At step 1428, the training process concludes when the model has successfully learned veracity assessment capabilities appropriate for the chosen deployment approach. For models trained without reconstruction loops, the system is ready for deployment with external enhancement components providing ongoing veracity support during inference. For models that complete reconstruction training, the system achieves self-sufficient veracity assessment capabilities and can operate independently while maintaining factual accuracy standards.

The veracity learning training process provides several key advantages over traditional transformer training approaches. The systematic integration of external knowledge assets ensures that the model learns from verified, authoritative sources rather than potentially unreliable training data. The supervised veracity flagging provides explicit guidance for distinguishing reliable from unreliable information patterns, enabling the model to develop robust accuracy assessment capabilities. The fusion approach allows seamless integration of external knowledge with natural language processing without disrupting the base model's linguistic competence. The frozen decoder teaching methodology ensures stability during enhancement training while preserving the model's existing capabilities. The optional reconstruction training provides a pathway toward self-sufficient veracity assessment that reduces deployment complexity. This comprehensive training approach addresses the critical challenge of factual accuracy in large language models while maintaining the natural language generation capabilities that make these systems valuable for practical applications.

The skilled person will be aware of a range of possible modifications of the various embodiments described above. Accordingly, the present invention is defined by the claims and their equivalents.

What is claimed is:

1. A transformer architecture for processing natural language input with enhanced computational efficiency and veracity verification, the system comprising:
a computer comprising a processor, a memory, and a plurality of programming instructions, the plurality of programming instructions, when executed by the processor, cause the processor to:
receive a natural language input comprising a plurality of tokens;
generate an enhanced embedding for each token, wherein the enhanced embedding comprises conventional word embeddings augmented with semantic, positional, reliability, syntactic, and domain-specific features;
analyze the enhanced embeddings to identify subject, verb, and object components in the natural language input,
for each token pair in the natural language input, calculate an attention score based on radial basis function (RBF) features, subject-verb-object triplets, and TF-IDF scores;
responsive to the attention score falling below a low threshold, omit the token pair from attention calculations;
responsive to the attention score exceeding a high threshold, route the token pair through a bypass system that transfers the token pair directly to an output layer without transformer processing;
responsive to the attention score being between the low threshold and the high threshold, process the token pair through a transformer stack to generate a preliminary output response;
verify the preliminary output response using a stored corpus of verified information using semantic distance measurements; and
responsive to a successful verification, generate a final response output with the preliminary output response, wherein the verification determines if the semantic distance between generated assertions from the preliminary output response and the stored corpus entries falls within acceptable thresholds.

2. The transformer architecture of claim 1, wherein the low threshold and the high threshold are dynamically adjusted based on content domain, sequence length, complexity, and historical performance metrics.

3. The transformer architecture of claim 1, wherein the low threshold and the high threshold are dynamically adjusted based on content domain, sequence length, complexity, and historical performance metrics.

3. The transformer architecture of claim 1, wherein to generate an enhanced embedding, the plurality of instructions, when executed by the processor, further cause the processor to:
determine positional encoding information indicating the token's position within the input,
calculate term frequency-inverse document frequency (TF-IDF) scores for the token;
determine radial basis function (RBF) features that identify vernacular subdomains within an embedding space;
incorporate semantic classes derived from co-occurrence matrix analysis, wherein the semantic classes capture statistical relationships between concept categories,
generate epistemic encoding data, wherein the epistemic encoding data is indicative of knowledge-related attributes of the token; and
combining traditional word embedding, positional encoding, TF-IDF scores, RBF features, and epistemic encoding data, into the enhanced embedding.

4. The transformer architecture of claim 1, wherein the stored corpus of verified information is organized using a hierarchical addressing system comprising volume identifiers, chapter identifiers, paragraph identifiers, sentence identifiers, and word identifiers, wherein each entry in the corpus includes attribution metadata indicating source reliability and temporal validity of the information.

5. The transformer architecture of claim 1, wherein the transformer stack comprises multi-headed self-attention layers operating on the enhanced embeddings, feed-forward neural networks, layer normalization components, and Long Short-Term Memory (LSTM) cells integrated within specific decoder layers for sequential processing.
